(19) United States
(12) Patent Application Publication
(10) Pub. No.: US 2013/0169409 A1
(43) Pub. Date: Jul. 4, 2013

(54) ANTI-COUNTERFEITING ARTICLE AND METHOD THEREOF

(71) Applicants: HSIN-PEI CHANG, Tu-Cheng (TW); ZONG-YUAN SUN, Tu-Cheng (TW); DA-HUA XIAO, Shenzhen City (CN)

(72) Inventors: HSIN-PEI CHANG, Tu-Cheng (TW); ZONG-YUAN SUN, Tu-Cheng (TW); DA-HUA XIAO, Shenzhen City (CN)

(21) Appl. No.: 13/653,102

(22) Filed: Oct. 16, 2012

(30) Foreign Application Priority Data
Dec. 30, 2011 (CN) 201110453209.X

(51) Int. Cl. G06F 7/04

(52) U.S. Cl. 340/5.8

(57) ABSTRACT

An anti-counterfeiting article includes a first part, a second part, a first radio frequency identification (RFID) tag, and a second RFID tag. The second part of the article is detachably attached to the first part. The first RFID tag is attached to the first part, and the second RFID tag is attached to the second part. The first RFID tag pre-stores a first identification code, the second RFID pre-stores a second identification code, the first identification code is identical with or is related to the second identification code in a some way or according to a predetermined criteria for confirming the status of the article as a certified product.

### BACKGROUND

1. Technical Field

The disclosure generally relates to anti-counterfeiting articles, and particularly relates to an anti-counterfeiting article using radio frequency identification (RFID) tags and a method thereof.

2. Description of the Related Art

Anti-counterfeiting methods and articles have evolved in retail business through the use of RFID tags. Referring to FIG. 3, a bottle 1 is shown. The bottle 1 contains articles, such as luxury beverage. To prevent counterfeiting, the bottle 1 often includes a bottle body 3 and a bottle cap 2. An RFID tag 4 pre-storing information of the beverage is attached to a joint of the bottle body 3 and the bottle cap 2. Thus, purchasers can get the information of the article by an RFID reader. Additionally, any attempt to remove the bottle cap 2 may cause the RFID tag 4 to be destroyed.

However, since the RFID tag 4 is frangible, and needs to be attached to the joint of the bottle body 2 and the bottle cap 3, the RFID tag 4 is difficult to automatically assemble or fix in place.

Therefore, there is room for improvement within the art.

### BRIEF DESCRIPTION OF THE DRAWINGS

Many aspects of an exemplary anti-counterfeiting article and method thereof can be better understood with reference to the drawings. The components in the drawings are not necessarily drawn to scale, the emphasis instead being placed upon clearly illustrating the principles of the disclosure.

FIG. 1 is an exploded view of an anti-counterfeiting article, according to an exemplary embodiment.

FIG. 2 is an assembled view of the anti-counterfeiting article as shown in FIG. 1.

FIG. 3 is a schematic view of an anti-counterfeiting article of related art.

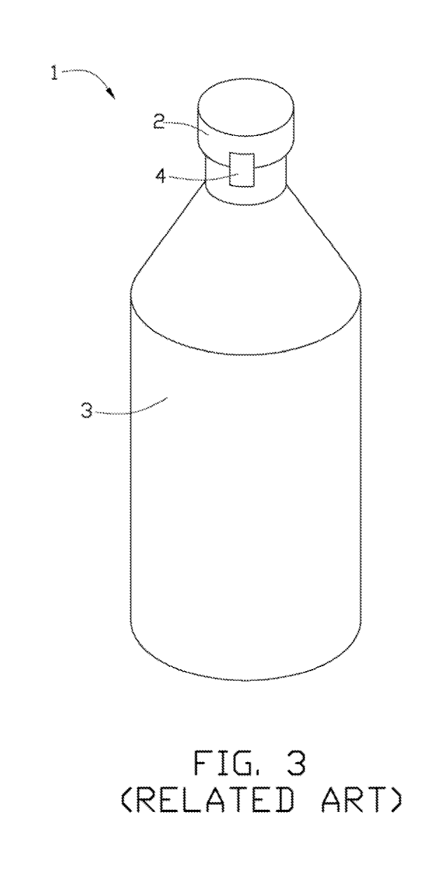

### DETAILED DESCRIPTION

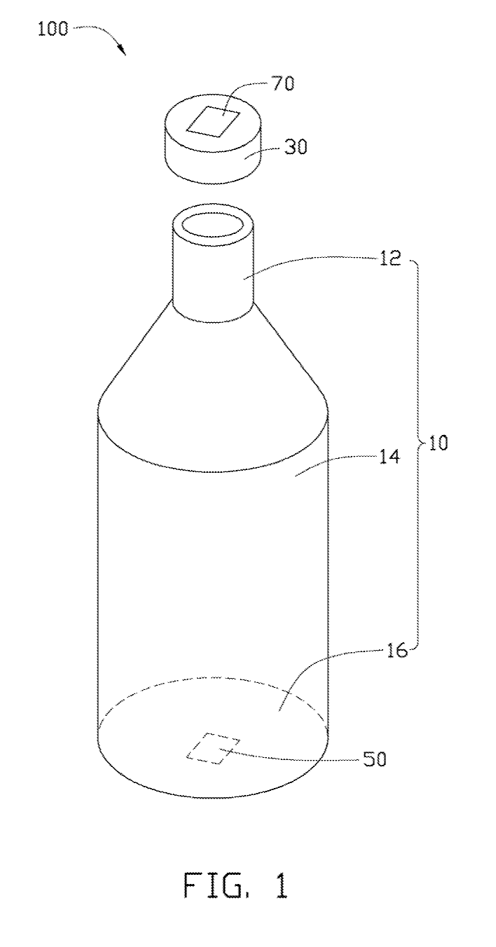

FIG. 1 is an exploded view of an anti-counterfeiting article 100 using RFID tags, according to an exemplary embodiment. The anti-counterfeiting article 100 can be a glass container for containing articles, such as beverages, or can be any other openable container.

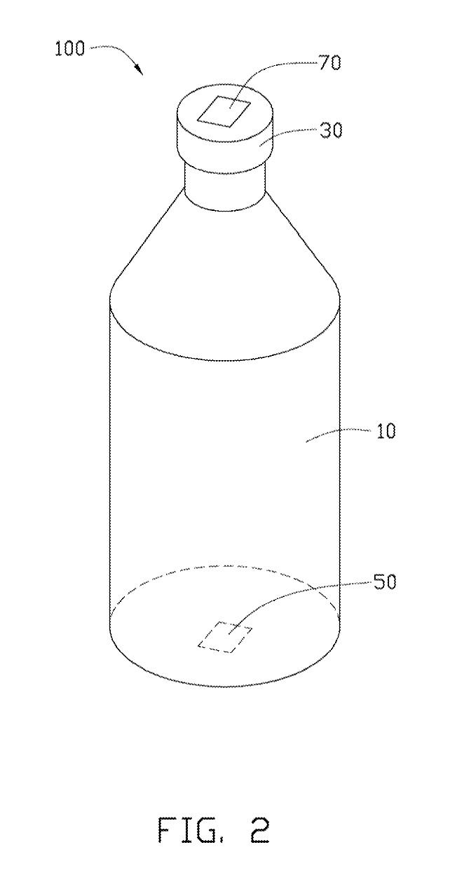

Also referring to FIG. 2, the anti-counterfeiting article 100 includes a first part and a second part detachably assembled to the first part. The anti-counterfeiting article 100 further includes a first RFID tag 50 and a second FRID tag 70 for confirming the status of the article as a certified product. The first RFID tag 50 is attached to the first part, and the second RFID tag 70 is attached to the second part.

In one exemplary embodiment, the anti-counterfeiting article 100 is a bottle, which includes a bottle housing 10 as the first part and a bottle cap 30 as the second part. The bottle housing 10 includes a bottle neck 12, a bottle body 14, and a bottle base 16. The bottle neck 12 and the bottle base 16 are formed on the two opposite ends of the bottle body 14. The bottle cap 30 is attached on the bottle neck 12.

The first RFID tag 50 can be attached to the bottle body 14 or the bottle base 16. In one exemplary embodiment, the first RFID tag 50 is attached on an external surface of the bottle base 16 via ultrasonic welding. The first RFID tag 50 pre-stores a first identification code of the article in the bottle 10 such as name, production date, and other verifying codes. The first RFID tag 50 can communicate with an RFID reader (not shown), to transmit the first identification code to the RFID reader.

The second RFID tag 70 is attached on an external surface of the bottle cap 30 via ultrasonic welding. The second RFID tag 70 pre-stores a second identification code of the article in the bottle 10 such as name, production date, and other verifying codes. The second RFID tag 70 can communicate with the RFID reader, to transmit the second identification code to the RFID reader. The second identification code can be identical to the first identification code, or be related to the first identification code in a some way or according to a predetermined criteria. For example, the first and second identification codes may be related as follows: if the first identification code is 010, the second identification code may be 101, which is the reverse of the verifying codes of the first identification code. In other exemplary embodiments, the second RFID tag 70 is attached on an internal surface of the bottle cap 30.

The first RFID tag 50 and the second RFID tag 70 are directly attached to the bottle housing 10 and the bottle cap 30 respectively, and do not need to be attached to a joint of the bottle housing 10 and the bottle cap 30, or to seal such a joint. Thus, the first RFID tag 50 and the second RFID tag 70 are easily attached to the bottle 10 and can be automatically assembled on the bottle 10 by simple processes.

When the anti-counterfeiting article 100 is sold, purchasers can obtain the first identification code of the first RFID tag 50 and the second identification code of the second RFID tag 70 via the RFID reader. If the first identification code is identical with or is related to the second identification code, the anti-counterfeiting article 100 may be considered a certified product. If the first identification code is different from or does not be related to the second identification code, the anti-counterfeiting article 100 may be considered a fake.

When the purchasers remove the bottle cap 30 from the bottle housing 10, the first RFID tag 50 and the second RFID tag 70 will not be destroyed. Additionally, the first RFID tag 50 and the second RFID tag 70 both together cannot be obtained by fakers, thus preventing mismatches of bottle housings 10 and bottle caps 30. Thus, purchasers can easily distinguish fakes from certified products and the counterfeit versions of the anti-counterfeiting article 100 are effectively prevented from entering into the market, increasing the worth and value of the anti-counterfeiting article 100.

The anti-counterfeiting article 100 can be assembled automatically. Moreover, the purchasers can effectively distinguish the fakes from the certified products via the first RFID tag 50 and the second RFID tag 70. Thus, the anti-counterfeiting function of the anti-counterfeiting article 100 is both convenient and efficient.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. An anti-counterfeiting article, comprising:
a first part;
a second part detachably attached to the first part;
a first radio frequency identification (RFID) tag attached to the first part; and
a second RFID tag attached to the second part;
wherein the first RFID tag pre-stores a first identification code, the second RFID pre-stores a second identification code, the first identification code is identical with or is related to the second identification code for confirming the status of the article as a certified product.

2. The anti-counterfeiting article as claimed in claim 1, wherein the anti-counterfeiting article is a bottle including a bottle housing and a bottle cap, the first part is the bottle housing, and the second part is the bottle cap.

3. The anti-counterfeiting article as claimed in claim 2, wherein the bottle housing includes a bottle base, the first RFID tag is attached on an external surface of the bottle base via ultrasonic welding.

4. The anti-counterfeiting article as claimed in claim 2, wherein the second RFID tag is attached on an external surface of the bottle cap via ultrasonic welding.

5. An anti-counterfeiting method for an article, the article including a first part and a second part detachably attached to the first part, the method comprising the steps:
obtaining a first identification code from a first radio frequency identification (RFID) tag attached to the first part;
obtaining a second identification code from the second RFID tag attached to the second part;
determining whether the first identification code is identical with or is related to the second identification code; and
confirming the article is a certified product or a fake according to the determination.

6. The anti-counterfeiting method for an article as claimed in claim 5, wherein if the first identification code is identical with or is related to the second identification code, the article is considered a certified product, if the first identification code is different from or dose not be related to the second identification code, the article is considered a fake.
